(19) United States
(12) Patent Application Publication
(10) Pub. No.: US 2025/0381822 A1
(43) Pub. Date: Dec. 18, 2025

(54) METHOD AND DEVICE FOR MANAGING REFRIGERATION QUALITY OF REFRIGERATED CARGO

(71) Applicants: HYUNDAI MOTOR COMPANY, Seoul (KR); Kia Corporation, Seoul (KR)

(72) Inventors: HyeonSeob KIM, Hwaseong-si (KR); Gwangseob KIM, Hwaseong-si (KR); Sae Yong JANG, Hwaseong-si (KR); Jungmo YU, Hwaseong-si (KR); Dokon KIM, Hwaseong-si (KR); Chan Seok CHOI, Hwaseong-si (KR)

(21) Appl. No.: 18/971,504

(22) Filed: Dec. 6, 2024

(30) Foreign Application Priority Data
Jun. 13, 2024 (KR) 10-2024-0076745

(51) Int. Cl. B60H 1/32

(52) U.S. Cl. CPC B60H 1/3205; B60H 1/3232; B60H 2001/3255

(57) ABSTRACT

A method and apparatus manage a refrigeration quality for a refrigerated cargo by detecting refrigeration condition abnormality of a refrigeration system of a vehicle. The method includes: receiving refrigeration quality reference data for the refrigerated cargo, obtaining a target temperature and an allowable time range data that are set based on the refrigeration quality reference data, determining whether an offset from the target temperature has occurred, comparing the allowable time range data with a duration for which the offset from the target temperature occurred, and determining, based on comparing the duration of the offset with the allowable time range data, whether the refrigeration system is in a suspected refrigeration condition abnormality state.

### CROSS-REFERENCE TO RELATED APPLICATION

This application claims priority to and the benefit of Korean Patent Application No. 10-2024-0076745, filed in the Korean Intellectual Property Office, on Jun. 13, 2024, the entire contents of which are incorporated herein by reference.

### TECHNICAL FIELD

The disclosure relates to a method and a device for managing refrigeration quality, and more particularly, to a refrigeration quality managing method and device for a refrigerated cargo by early detection of abnormalities of a refrigeration condition in a refrigeration system installed in a vehicle.

### BACKGROUND

Purpose Built Vehicles (PBVs) are electrified and modular mobility, which may be defined as transportation means that are based on personalized design for its purpose of use. In other words, PBVs are vehicles that are designed and built for a specific purpose or requirement and have a specific function or use in mind, as opposed to a typical passenger vehicle. For example, refrigerated vehicles may be specialized vehicles used to transport temperature-sensitive goods, such as food, pharmaceuticals, and biochemicals. Refrigerated vehicles may include a cooling system for controlling the internal temperature to ensure that the goods remain in the proper condition until the goods reach their destination. The refrigerated vehicles may be developed based on PBVs with eco-friendly objectives and come with associated solutions and services.

In some cases, drivers of refrigerated vehicles may be responsible for refrigeration quality of refrigerated cargo. Refrigeration quality may deteriorate due to temperature deviations from a target temperature of a refrigeration compartment. In some cases, where the driver's attention is focused on the operation of the vehicle, it may be difficult to directly manage the refrigeration quality of the refrigeration compartment.

### SUMMARY

The present disclosure describes a refrigeration quality managing method and apparatus that are capable of conveniently and precisely managing refrigeration quality by early detecting abnormality in a refrigeration condition of a refrigeration system of a vehicle.

According to one aspect of the subject matter described in this application, a method manages a refrigeration quality of a refrigerated cargo by detecting refrigeration condition abnormality of a refrigeration system of a vehicle. The includes receiving, from a server, refrigeration quality reference data for the refrigerated cargo; obtaining (i) a reference temperature data including a target temperature of a refrigeration compartment of the vehicle and (ii) an allowable time range data including a preset allowable time range for detecting the refrigeration condition abnormality, the reference temperature data and the allowable time range data being set based on the refrigeration quality reference data; determining whether an offset of a refrigeration compartment temperature of the vehicle from the target temperature has occurred; based on determining that the offset from the target temperature has occurred, comparing the allowable time range data with a duration for which the offset has lasted; and based on comparing the allowable time range data with the duration of the offset, determining whether the refrigeration system is in a suspected refrigeration condition abnormality state.

Implementations according to this aspect can include one or more of the following features. For example, the reference temperature data include a single value indicative of the target temperature, where the method may further include obtaining, from the refrigeration quality reference data, allowable temperature range data including a preset allowable temperature range for detecting the refrigeration condition abnormality. Determining whether the offset from the target temperature has occurred may include: determining an upper offset temperature limit and a lower offset temperature limit by using the single value and the allowable temperature range data; determining that the offset from the target temperature has occurred based on the refrigeration compartment temperature (i) exceeding the upper offset temperature limit or (ii) being less than the lower offset temperature limit; and determining that the offset from the target temperature has not occurred based on the refrigeration compartment temperature (i) being less than or equal to than the upper offset temperature limit and (ii) being greater than or equal to the lower offset temperature limit.

In some implementations, the allowable temperature range data include first allowable temperature range data and second allowable temperature range data. Determining the upper offset temperature limit and the lower offset temperature limit may include: determining the upper offset temperature limit by adding the first allowable temperature range data to the single value; and determining the lower offset temperature limit by subtracting the second allowable temperature range data from the single value.

In some implementations, the reference temperature data may include a target upper limit temperature and a target lower limit temperature that define a range of the target temperature, where determining whether the offset from the target temperature has occurred may include: determining that the offset from the target temperature has occurred based on the refrigeration compartment temperature (i) exceeding the target upper limit temperature or (ii) being lower than the target lower limit temperature; and determining that the offset from the target temperature has not occurred based on the refrigeration compartment temperature (ii) being less than or equal to the target upper limit temperature and (ii) being greater than or equal to the target lower limit temperature.

In some implementations, determining whether the refrigeration system is in the suspected refrigeration condition abnormality state may include: determining that the refrigeration system is in the suspected refrigeration condition abnormality state based on the duration of the offset exceeding the allowable time range data; and determining that the refrigeration system is not in the suspected refrigeration condition abnormality state based on the duration of the offset being less than or equal to the allowable time range data.

In some implementations, the method may further include: obtaining, from the refrigeration quality reference data, allowable reference deviation data including a preset allowable reference deviation for detecting the refrigeration condition abnormality; determining a refrigeration allowable deviation based on (i) determining that the offset from the target temperature has not occurred or (ii) the duration of the offset being less than or equal to the allowable time range data; and based on comparing the refrigeration allowable deviation to the allowable reference deviation data, determining whether the refrigeration system is in the suspected refrigeration condition abnormality state.

In some examples, determining whether the refrigeration system is in the suspected refrigeration condition abnormality state may include: determining that the refrigeration system is in the suspected refrigeration condition abnormality state based on the refrigeration allowable deviation exceeding the allowable reference deviation data; and determining that the refrigeration system is not in the suspected refrigeration condition abnormality state based on the refrigeration allowable deviation being less than or equal to the allowable reference deviation data. In some examples, determining the refrigeration allowable deviation may include: determining the refrigeration allowable deviation by the duration of the offset divided by a total operating time of a refrigeration unit of the vehicle.

In some implementations, the refrigeration quality reference data may include (i) a plurality of types of the refrigerated cargo, (ii) the reference temperature data corresponding to each type of the refrigerated cargo, (iii) the allowable temperature range data corresponding to each type of the refrigerated cargo, (iv) the allowable time range data corresponding to each type of the refrigerated cargo, and (v) the allowable reference deviation data corresponding to each type of the refrigerated cargo. In some implementations, the method may further include outputting a notification regarding the suspected refrigeration condition abnormality state through one or more interfaces of the vehicle.

According to another aspect, a method manages a refrigeration quality of a refrigerated cargo by detecting refrigeration condition abnormality of a refrigeration system of a vehicle. The method includes: recognizing a type of the refrigerated cargo loaded into the vehicle by using a cargo recognition device disposed at the vehicle; receiving, from a server, refrigeration quality reference data for the refrigerated cargo; obtaining (i) a reference temperature data including a target temperature of a refrigeration compartment of the vehicle and (ii) an allowable time range data including a preset allowable time range for detecting the refrigeration condition abnormality, the reference temperature data and the allowable time range data being set based on the refrigeration quality reference data; determining whether an offset of a refrigeration compartment temperature of the vehicle from the target temperature has occurred; based on determining that the offset from the target temperature has occurred, comparing the allowable time range data with a duration for which the offset lasted; and based on comparing the allowable time range data with the duration of the offset, determining whether the refrigeration system is in a suspected refrigeration condition abnormality state.

Implementations according to this aspect can include one or more of the following features or the features described above. For example, the cargo recognition device may include a radio frequency identification (RFID) device or a near field communication (NFC) device.

In some implementations, the reference temperature data include a single value indicative of the target temperature, where the method may further include obtaining, from the refrigeration quality reference data, allowable temperature range data including a preset allowable temperature range for detecting the refrigeration condition abnormality. Determining whether the offset from the target temperature has occurred may include: determining an upper offset temperature limit and a lower offset temperature limit by using the single value and the allowable temperature range data; determining that the offset from the target temperature has occurred based on the refrigeration compartment temperature (i) exceeding the upper offset temperature limit or being lower than the lower offset temperature limit; and determining that the offset from the target temperature has not occurred based on the refrigeration compartment temperature (i) being less than or equal to the upper offset temperature limit and (ii) being greater than or equal to the lower offset temperature limit.

In some examples, the allowable temperature range data include first allowable temperature range data and second allowable temperature range data, where determining the upper offset temperature limit and the lower offset temperature limit may include: determining the upper offset temperature limit by adding the first allowable temperature range data to the single value; and determining the lower offset temperature limit by subtracting the second allowable temperature range data from the single value.

In some examples, the reference temperature data include a target upper limit temperature and a target lower limit temperature that define a range of the target temperature, where determining whether the offset from the target temperature has occurred may include: determining that the offset from the target temperature has occurred based on the refrigeration compartment temperature (i) exceeding the target upper limit temperature or (ii) being lower than the target lower limit temperature; and determining that the offset from the target temperature has not occurred based on the refrigeration compartment temperature (i) being less than or equal to the target upper limit temperature and (ii) being greater than or equal to the target lower limit temperature.

In some implementations, the method may further include obtaining, from the refrigeration quality reference data, allowable reference deviation data including a preset allowable reference deviation for detecting the refrigeration condition abnormality; determining a refrigeration allowable deviation based on (i) determining that the offset from the target temperature has not occurred or (ii) the duration of the offset being less than or equal to the allowable time range data; and based on comparing the refrigeration allowable deviation with the allowable reference deviation data, determining whether the refrigeration system is in the suspected refrigeration condition abnormality state.

In some examples, the refrigeration quality reference data include (i) a plurality of types of the refrigerated cargo, (ii) the reference temperature data corresponding to each type of the refrigerated cargo, (iii) the allowable temperature range data corresponding to each type of the refrigerated cargo, (iv) the allowable time range data corresponding to each type of the refrigerated cargo, and (v) the allowable reference deviation data corresponding to each type of the refrigerated cargo. In some implementations, the method may further include outputting a notification regarding the suspected refrigeration condition abnormality state through one or more interfaces of the vehicle.

According to another aspect, an apparatus is configured to manage a refrigeration quality of a refrigerated cargo based on detecting refrigeration condition abnormality of a refrigeration system of a vehicle. The apparatus includes one or more processes configured to execute a program code loaded in one or more memory devices. The one or more processes are configured to: receive, from a server, refrigeration quality reference data of the refrigerated cargo; obtain (i) a reference temperature data including a target temperature of a refrigeration compartment of the vehicle and (ii) an allowable time range data including a preset allowable time range for detecting the refrigeration condition abnormality, the reference temperature data and the allowable time range data being set based on the refrigeration quality reference data; determine whether an offset of a refrigeration compartment temperature of the vehicle from the target temperature has occurred; based on determining that the offset from the target temperature has occurred, compare the allowable time range data with a duration for which the offset has lasted; and based on comparing the allowable time range data with the duration of the offset, determine whether the refrigeration system is in a suspected refrigeration condition abnormality state.

Implementations according to this aspect can include one or more of the following features. For example, the reference temperature data include a single value indicative of the target temperature, where the one or more processes are further configured to: obtain, from the refrigeration quality reference data, allowable temperature range data including a preset allowable temperature range for detecting the refrigeration condition abnormality; determine an upper offset temperature limit and a lower offset temperature limit by using the single value and the allowable temperature range data; determine that the offset from the target temperature has occurred based on the refrigeration compartment temperature (i) exceeding the upper offset temperature limit or (ii) being lower than the lower offset temperature limit; and determine that the offset from the target temperature has not occurred based on the refrigeration compartment temperature (i) being less than or equal to the upper offset temperature limit and (ii) being greater than or equal to the lower offset temperature limit.

In some examples, the allowable temperature range data include first allowable temperature range data and second allowable temperature range data, where the one or more processes are further configured to: determine the upper offset temperature limit by adding the first allowable temperature range data to the single value; and determine the lower offset temperature limit by subtracting the second allowable temperature range data from the single value.

In some examples, the reference temperature data include a target upper limit temperature and a target lower limit temperature indicative of a range of the target temperature, where the one or more processes are further configured to: determine that the offset from the target temperature has occurred based on the refrigeration compartment temperature (i) exceeding the target upper limit temperature or (ii) being lower than the target lower limit temperature; and determine that the offset from the target temperature has not occurred based on the refrigeration compartment temperature (i) being less than or equal to the target upper limit temperature and (ii) being greater than or equal to the target lower limit temperature.

In some examples, the one or more processes are further configured to: determine that the refrigeration system is in the suspected refrigeration condition abnormality state based on the duration of the offset exceeding the allowable time range data; and determine that the refrigeration system is not in the suspected refrigeration condition abnormality state based on the duration of the offset being less than or equal to the allowable time range data. In some examples, the one or more processes are further configured to: obtain, from the refrigeration quality reference data, allowable reference deviation data including a preset allowable reference deviation for detecting the refrigeration condition abnormality; determine a refrigeration allowable deviation based on (i) determining that the offset from the target temperature has not occurred or (ii) the duration of the offset being less than or equal to the allowable time range data; and based on comparing the refrigeration allowable deviation with the allowable reference deviation data, determine whether the refrigeration system is in the suspected refrigeration condition abnormality state.

In some examples, the one or more processes are further configured to determine that the refrigeration system is in the suspected refrigeration condition abnormality state based on the refrigeration allowable deviation exceeding the allowable reference deviation data; and determine that the refrigeration system is not in the suspected refrigeration condition abnormality state based on the refrigeration allowable deviation being less than or equal to the allowable reference deviation data.

### BRIEF DESCRIPTION OF THE DRAWINGS

FIG. 1 is a diagram illustrating an example of a refrigeration quality managing system.

FIG. 2 is a diagram illustrating an example of a refrigeration quality managing device.

FIG. 3 is a diagram illustrating an example of refrigeration quality reference data.

FIG. 4 is a diagram illustrating an example of a refrigeration quality managing system.

FIG. 5 is a diagram illustrating an example of a refrigeration quality managing system.

FIG. 6 is a diagram illustrating an example of a refrigeration quality managing method.

FIG. 7 is a diagram illustrating an example of a refrigeration quality managing method.

FIG. 8 is a diagram illustrating the refrigeration quality managing method.

FIG. 9 is a diagram illustrating an example of the refrigeration quality managing method and device.

FIG. 10 is a diagram illustrating an example of a computing device.

### DETAILED DESCRIPTION

Hereinafter, the present disclosure will be described more fully hereinafter with reference to the accompanying drawings, in which examples of the disclosure are shown. As those skilled in the art would realize, the described examples can be modified in various different ways, all without departing from the spirit or scope of the present disclosure. Accordingly, the drawings and description are to be regarded as illustrative in nature and not restrictive. Like reference numerals designate like elements throughout the specification.

Terms such as “part,” “unit,” “module,” and the like in the specification can refer to a unit capable of performing at least one function or operation described herein, which can be implemented in hardware or circuitry, software, or a combination of hardware or circuitry and software. In addition, at least some of the configurations or functions of a refrigeration quality managing method and devices described below can be implemented as programs or software, and the programs or software can be stored on a computer-readable medium.

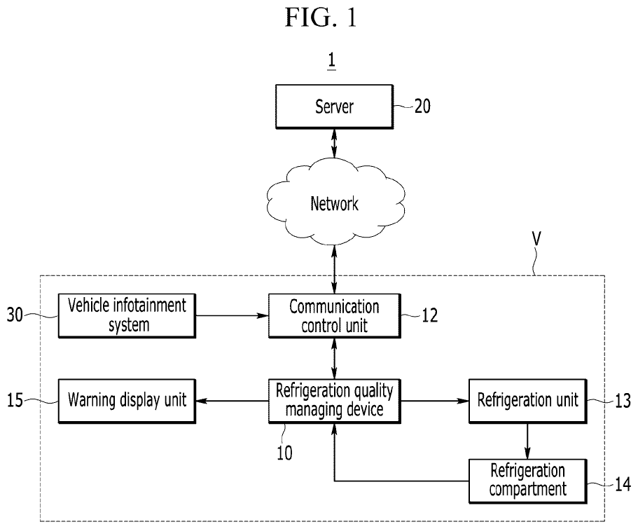

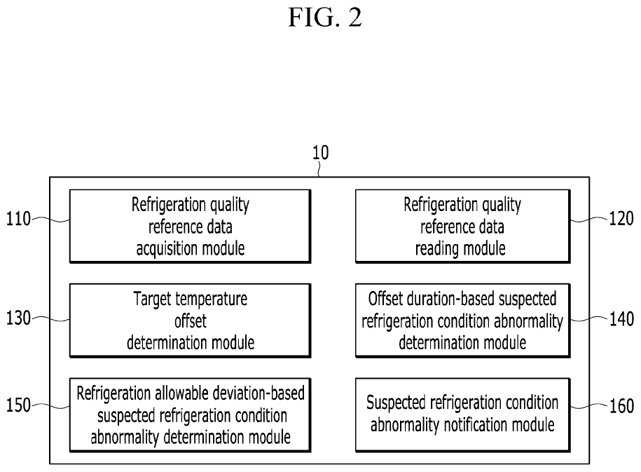

FIG. 1 is a diagram illustrating an example of a refrigeration quality managing system, and FIG. 2 is a diagram illustrating an example of a refrigeration quality managing device.

In some implementations, referring to FIGS. 1 and 2, a refrigeration quality management system 1 can include a vehicle V including a refrigeration quality managing device 10 and a server 20. The vehicle V and the server 20 can exchange data with each other via a network. That is, the vehicle V can transmit information about refrigerated cargo through the communication of the server 20, receive refrigeration quality reference data for the refrigerated cargo, and manage the refrigeration quality of the refrigerated cargo based on the refrigeration quality reference data. In some examples, the vehicle V can communicate with the server 20 through a cellular network, including 4G, 5G, and the like.

In some examples, the vehicle V can include the refrigeration quality managing device 10, a communication interface 12, a refrigeration unit 13, a refrigeration compartment 14, a warning display unit 15, and a vehicle infotainment system 30. The refrigeration unit 13 can include a power supply and a heat exchanger. The power supply can provide power to several components within the refrigeration unit, including a compressor. The refrigeration unit 13 can refer to or be part of the refrigeration system of the vehicle V. The compressor can then compress a refrigerant to start a refrigeration cycle, and the refrigerant can be converted from a gaseous state to a high-pressure and high-temperature state. The compressed refrigerant is then moved to the heat exchanger, and the refrigerant in the heat exchanger can release heat through heat exchange with the surrounding air and be condensed to a liquid state. As this process of power supply and heat exchange is repeated, continuous cooling can be realized. The refrigeration compartment 14 can be equipped with a temperature sensor for measuring a temperature inside the refrigeration compartment 14.

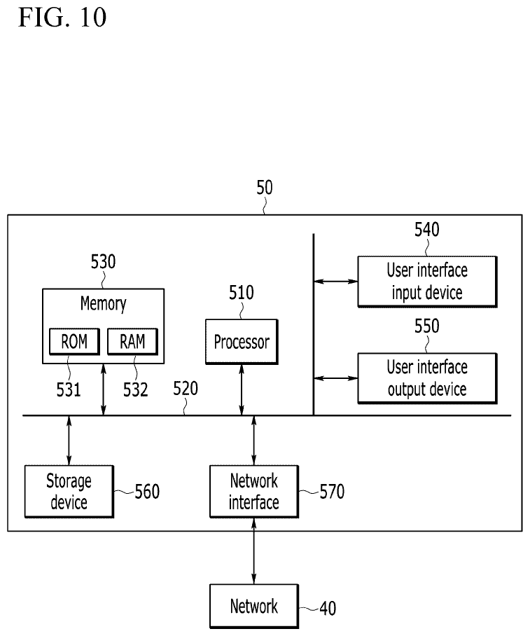

The refrigeration quality managing device 10 can execute a program code loaded into one or more memory devices through one or more processors. For example, the refrigeration quality managing device 10 can be implemented as a computing device 50, such as that described later with reference to FIG. 10. In this case, the one or more processors can correspond to a processor 510 of the computing device 50, and the one or more memory devices can correspond to a memory 530 of the computing device 50. The program code can be executed by one or more processors to manage the quality of refrigeration for a refrigerated cargo by early detecting refrigeration condition abnormalities in the refrigeration system installed in the vehicle. The term “module” is used herein to logically distinguish between these functions executed by the program code.

The refrigeration quality managing device 10 can include a refrigeration quality reference data acquisition module 110, a refrigeration quality reference data reading module 120, a target temperature offset determination module 130, an offset duration-based suspected refrigeration condition abnormality determination module 140, a refrigeration allowable deviation-based suspected refrigeration condition abnormality determination module 150, and a suspected refrigeration condition abnormality notification module 160.

The refrigeration quality reference data acquisition module 110 can receive, from the server 20, refrigeration quality reference data set for each refrigerated cargo. The refrigeration quality reference data can include data that define a target temperature for the refrigeration compartment 14 to maintain for each type of refrigerated cargo, define a range of temperature change that is allowed to deviate from the target temperature, and/or define a time range that is allowed to deviate from the target temperature.

Specifically, a user (e.g., a driver of a refrigerated vehicle) can input the type of refrigerated cargo that is loaded into the refrigerated vehicle via the vehicle infotainment system 30. For example, the user can input whether the refrigerated cargo loaded into the refrigerated vehicle corresponding to the type of ice cream, frozen fish, frozen processed food, or the like.

In some examples, the vehicle infotainment system 30 can receive input from a user, via a user interface, regarding the type of refrigerated cargo before operation of the refrigeration unit 13 begins. Subsequently, the vehicle infotainment system 30 can transmit information regarding the type of refrigerated cargo input from the user to the server 20 via the communication interface 12. Upon receiving the information, the server 20 can provide the refrigeration quality reference data corresponding to the type of refrigerated cargo to the refrigeration quality managing device 10 via the communication interface 12.

The refrigeration quality reference data reading module 120 can read reference temperature data, allowable temperature range data, and allowable time range data set based on the refrigeration quality reference data received from the server 20. The reference temperature data can include a refrigeration compartment target temperature, the allowable temperature range data can include a preset allowable temperature range for detecting refrigeration condition abnormality, and the allowable time range data can include a preset allowable time range for detecting refrigeration condition abnormality. In some examples, the reference temperature data can be implemented to include a single value representing a specific target temperature. In this case, to determine the target temperature offset, an upper offset temperature limit and a lower offset temperature limit can be computed by using the single value and the allowable temperature range data, and then it can be determined whether the refrigeration compartment temperature falls between the upper offset temperature limit and the lower offset temperature limit. In some examples, the reference temperature data can be implemented to include values for a target upper limit temperature and a target lower limit temperature that represent a range of temperatures that are recognized as the target temperature. In this case, to determine the target temperature offset, it can be immediately determined whether the refrigeration compartment temperature falls between the target upper limit temperature and the target lower limit temperature.

The target temperature offset determination module 130 can determine whether an offset from the target temperature has occurred based on the refrigeration compartment temperature and the reference temperature data. In some examples, when the reference temperature data include a single value indicative of the target temperature, the target temperature offset determination module 130 can compute an upper offset temperature limit and a lower offset temperature limit using the single value and the allowable temperature range data. The target temperature offset determination module 130 can compare the upper offset temperature limit and the lower offset temperature limit to a temperature in the refrigeration compartment 14 to determine whether offset from the target temperature has occurred.

Specifically, the target temperature offset determination module 130 can determine that the offset from the target temperature has occurred when the temperature in the refrigeration compartment 14 exceeds the upper offset temperature limit, or when the temperature of the refrigeration compartment 14 is lower than the lower offset temperature limit. Alternatively, when the temperature in the refrigeration compartment 14 is less than or equal to the upper offset temperature limit and the temperature in the refrigeration compartment 14 is greater than or equal to the lower offset temperature limit, the target temperature offset determination module 130 can determine that the offset from the target temperature has not occurred.

In some examples, the allowable temperature range data include first allowable temperature range data and second allowable temperature range data, and the target temperature offset determination module 130 can compute the upper offset temperature limit by adding the first allowable temperature range data to the single value representing the target temperature, and compute the lower offset temperature limit by subtracting the second allowable temperature range data from the single value representing the target temperature. For example, when the single value representing the target temperature is −15 degrees Celsius, the first allowable temperature range data are 3 degrees Celsius, and the second allowable temperature range data are 5 degrees Celsius, the target temperature offset determination module 130 can compute −12 degrees Celsius as the upper offset temperature limit by adding the first allowable temperature range data to the single value representing the target temperature, and compute −20 degrees Celsius as the lower offset temperature limit by subtracting the second allowable temperature range data from the single value representing the target temperature.

In this case, the target temperature offset determination module 130 can determine that the offset from the target temperature has occurred when the temperature in the refrigeration compartment 14 exceeds −12 degrees Celsius, or when the temperature of the refrigeration compartment 14 is lower than −20 degrees Celsius. Alternatively, when the temperature in the refrigeration compartment 14 is less than or equal to −12 degrees Celsius and the temperature in the refrigeration compartment 14 is greater than or equal to −20 degrees Celsius, the target temperature offset determination module 130 can determine that the offset from the target temperature has not occurred.

In some examples, the first allowable temperature range data and the second allowable temperature range data can have the same value. For example, when the single value representing the target temperature is −15 degrees Celsius, the first allowable temperature range data are 3 degrees Celsius, and the second allowable temperature range data are also 3 degrees Celsius, the target temperature offset determination module 130 can compute −12 degrees Celsius as the upper offset temperature limit by adding the first allowable temperature range data to the single value representing the target temperature, and compute −18 degrees Celsius as the lower offset temperature limit by subtracting the second allowable temperature range data from the single value representing the target temperature.

In this case, the target temperature offset determination module 130 can determine that the offset from the target temperature has occurred when the temperature in the refrigeration compartment 14 exceeds −12 degrees Celsius, or when the temperature of the refrigeration compartment 14 is lower than −18 degrees Celsius. Alternatively, when the temperature in the refrigeration compartment 14 is less than or equal to −12 degrees Celsius and the temperature in the refrigeration compartment 14 is greater than or equal to −18 degrees Celsius, the target temperature offset determination module 130 can determine that the offset from the target temperature has not occurred.

In some examples, where the reference temperature data include a target upper limit temperature and a target lower limit temperature that represent a range of target temperatures, the target temperature offset determination module 130 can compare the temperature of the refrigeration compartment 14, the target upper limit temperature, and the target lower limit temperature to determine whether offset from the target temperature has occurred.

Specifically, the target temperature offset determination module 130 can determine that the offset from the target temperature has occurred when the temperature in the refrigeration compartment 14 exceeds the target upper limit temperature, or when the temperature of the refrigeration compartment 14 is lower than the target lower limit temperature. Alternatively, when the temperature in the refrigeration compartment 14 is less than or equal to the target upper limit temperature and the temperature in the refrigeration compartment 14 is greater than or equal to the target lower limit temperature, the target temperature offset determination module 130 can determine that the offset from the target temperature has not occurred. For example, when the target upper limit temperature is −12 degrees Celsius and the target lower limit temperature is −20 degrees Celsius, the target temperature offset determination module 130 can determine that an offset from the target temperature has occurred when the temperature in the refrigeration compartment 14 exceeds −12 degrees Celsius, or when the temperature of the refrigeration compartment 14 is lower than −20 degrees Celsius. Alternatively, when the temperature in the refrigeration compartment 14 is less than or equal to −12 degrees Celsius and the temperature in the refrigeration compartment 14 is greater than or equal to −20 degrees Celsius, the target temperature offset determination module 130 can determine that the offset from the target temperature has not occurred.

When it is determined that the offset from the target temperature has occurred, the offset duration-based suspected refrigeration condition abnormality determination module 140 can compare duration of the offset of the offset from the target temperature in the refrigeration compartment 14 to the allowable time range data read from the refrigeration quality reference data. The offset duration-based suspected refrigeration condition abnormality determination module 140 can determine whether the refrigeration system of the vehicle V is in a suspected refrigeration condition abnormality state based on the comparison of the duration of the offset and the allowable time range data.

Specifically, the offset duration-based suspected refrigeration condition abnormality determination module 140 can determine that the refrigeration condition abnormality is suspected when the duration of the offset exceeds the allowable time range data. In some examples, the offset duration-based suspected refrigeration condition abnormality determination module 140 can determine that the refrigeration condition abnormality is not suspected when the duration of the offset is less than or equal to the allowable time range data.

For example, assuming that the allowable time range data are 10 minutes, when the duration of the offset (i.e., when the single value representing the target temperature is −15 degrees Celsius, the first allowable temperature range data are 3 degrees Celsius, the second allowable temperature range data are 5 degrees Celsius, or when the target upper limit temperature is −12 degrees Celsius and the target lower limit temperature is −20 degrees Celsius, the temperature in the refrigeration compartment 14 exceeds −12 degrees Celsius, or the duration time in which the temperature of the refrigeration compartment is less than −20 degrees Celsius) has elapsed for 12 minutes, then the offset duration-based suspected refrigeration condition abnormality determination module 140 can determine that the refrigeration condition abnormality is suspected. In some examples, the offset duration-based suspected refrigeration condition abnormality determination module 140 can determine that the refrigeration condition abnormality is not suspected when the duration of the offset has elapsed 6 minutes.

In some examples, the refrigeration quality reference data reading module 120 can read allowable reference deviation data from the refrigeration quality reference data received from the server 20. The allowable reference deviation data can include a preset allowable reference deviation for detecting refrigeration condition abnormality.

The target temperature offset determination module 130 can determine whether an offset from the target temperature has occurred by using the reference temperature data and the allowable temperature range data read from the refrigeration quality reference data. When it is determined that the offset from the target temperature has not occurred, the refrigeration allowable deviation-based suspected refrigeration condition abnormality determination module 150 can compute a refrigeration allowable deviation according to a predetermined manner.

When it is determined that the offset from the target temperature has occurred, the offset duration-based suspected refrigeration condition abnormality determination module 140 can compare duration of the offset of the offset from the target temperature in the refrigeration compartment 14 to the allowable time range data read from the refrigeration quality reference data. When the duration of the offset is less than or equal to the allowable time range data, the refrigeration allowable deviation-based suspected refrigeration condition abnormality determination module 150 can compute a refrigeration allowable deviation according to a predetermined manner.

The refrigeration allowable deviation-based suspected refrigeration condition abnormality determination module 150 can determine whether the refrigeration system of the vehicle V is in a suspected refrigeration condition abnormality state based on the comparison of the refrigeration allowable deviation and the allowable reference deviation data read from the refrigeration quality reference data.

Specifically, the refrigeration allowable deviation-based suspected refrigeration condition abnormality determination module 150 can determine that the refrigeration condition abnormality is suspected when the refrigeration allowable deviation exceeds the allowable reference deviation data. In some examples, when the refrigeration allowable deviation is less than or equal to the allowable reference deviation data, the refrigeration allowable deviation-based suspected refrigeration condition abnormality determination module 150 can determine that the refrigeration condition abnormality is not suspected.

For example, when the refrigeration allowable deviation computed according to the predetermined manner is 4%, assuming that the allowable reference deviation data are 3%, the refrigeration allowable deviation-based suspected refrigeration condition abnormality determination module 150 can determine that the refrigeration condition abnormality is suspected. In some examples, when the refrigeration allowable deviation computed according to the predetermined manner is 1%, the refrigeration allowable deviation-based suspected refrigeration condition abnormality determination module 150 can determine that the refrigeration condition abnormality is not suspected.

In some examples, the refrigeration allowable deviation-based suspected refrigeration condition abnormality determination module 150 can compute the refrigeration allowable deviation according to Equation 1 below.

### Equation 1

Refrigeration allowable deviation=duration of the offset from the target temperature/total operating time of refrigeration unit

In some examples, the refrigeration quality reference data managed by the server 20 can be implemented as a specific data structure. In some examples, the server 20 can include at least one processor, electrical circuit, memory, or cloud server that stores and provides the specific data structure. Specifically, the refrigeration quality reference data can be defined as a data structure in the form of a two-dimensional array, with the type of refrigerated cargo along the Y axis and reference temperature data, allowable temperature range data, allowable time range data, and allowable reference deviation data along the X axis.

The suspected refrigeration condition abnormality notification module 160 can output a notification for the suspected refrigeration condition abnormality state through one or more interfaces installed in the vehicle V. For example, the suspected refrigeration condition abnormality notification module 160 can output the notification for the suspected refrigeration condition abnormality state via a cluster, center fascia, or the like.

In some cases, drivers operating refrigeration vehicles may periodically stop the vehicle to check the refrigeration quality of refrigerated cargo and open the refrigeration compartment to manually check the temperature, which delayed logistics time and caused driver fatigue, adversely affecting safe operation. In addition, the process of opening the refrigeration compartment increases a temperature, which reduces the refrigeration quality or increased the operation of the refrigeration unit, resulting in increased energy consumption. Furthermore, in providing logistics services, it is difficult to quickly detect the deterioration of refrigeration quality, when quality abnormality occurs, which may lead to a loss of time and cost to respond to quality abnormality occurrence.

According to the present disclosure, it can be possible to manage refrigeration quality reference data, including data such as target temperature, allowable temperature range, allowable time range, and allowable reference deviation, for each refrigerated cargo, and quickly detecting the suspected refrigeration condition abnormality state by considering the refrigeration quality reference data and the refrigeration condition of the vehicle.

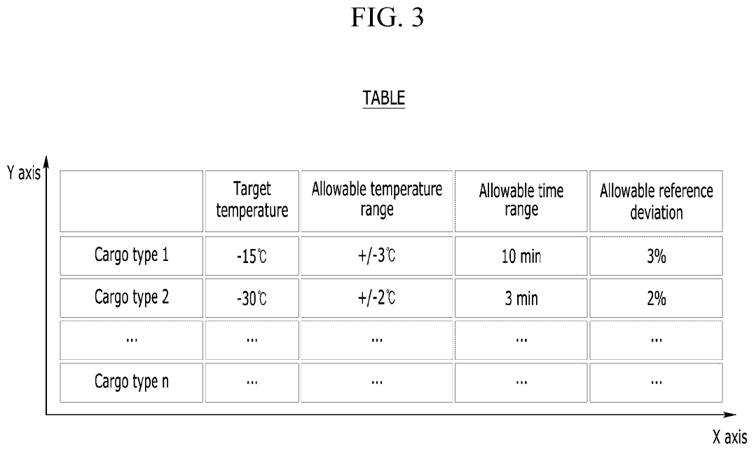

FIG. 3 is a diagram illustrating an example of refrigeration quality reference data.

Referring to FIG. 3, the refrigeration quality reference data can include data regarding a target temperature, an allowable temperature range, an allowable time range, and an allowable reference deviation set for cargo type 1, cargo type 2, . . . , cargo type n (where n is a natural number). Specifically, the refrigeration quality reference data are defined as a data structure in the form of a two-dimensional array (i.e., a table structure), with the type of refrigerated cargo as the Y axis, and the reference temperature data, the allowable temperature range data, the allowable time range data, and the allowable reference deviation data as the X-axis, and for cargo type 1 (e.g., frozen processed food), a target temperature can be set to −15 degrees Celsius, an allowable temperature range can be set to +3 degrees Celsius and −3 degrees Celsius, an allowable time range can be set to 10 minutes, and an allowable reference deviation can be set to 3%. For cargo type 2 (e.g., frozen fish), a target temperature can be set to −30 degrees Celsius, an allowable temperature range can be set to +2 degrees and −2 degrees Celsius, an allowable time range can be set to 3 minutes, and an allowable reference deviation can be set to 2%.

When a user (e.g., a driver of a refrigeration vehicle), for example, via the vehicle infotainment system 30, inputs a type of refrigerated cargo loaded into the refrigeration vehicle as cargo type 1, the server 20 receiving the corresponding information can provide the refrigeration quality reference data corresponding to cargo type 1 to the refrigeration quality managing device 10 via the communication interface 12. Accordingly, the refrigeration quality managing device 10 can perform refrigeration quality management with the reference of the target temperature of −15 degrees Celsius, the allowable temperature range of +3 degrees Celsius and −3 degrees Celsius, the allowable time range of 10 minutes, and the allowable reference deviation of 3%. In some examples, when the user inputs the type of refrigerated cargo as cargo type 2, the server 20 receiving the corresponding information can provide the refrigeration quality reference data corresponding to cargo type 2 to the refrigeration quality managing device 10 via the communication interface 12. Accordingly, the refrigeration quality managing device 10 can perform refrigeration quality management with the reference of the target temperature of −30 degrees Celsius, the allowable temperature range of +2 degrees Celsius and −2 degrees Celsius, the allowable time range of 3 minutes, and the allowable reference deviation of 2%.

In some examples, the refrigeration quality reference data can be corrected by considering factors, such as the age of the refrigeration unit 13, the total number of hours of use of the refrigeration unit 13, the weight and volume of the cargo, the expected driving time of the vehicle V, and the outside weather. For example, the conditions of the allowable temperature range and the allowable time range can be tightened to reflect the inherent characteristics and performance of the refrigeration unit 13 in consideration of the age, in the case of the aged refrigeration unit 13 or when the total usage time of the refrigeration unit 13 is longer than the average usage time per age of the refrigeration unit to determine the degree of usage of the refrigeration unit 13 relative to its age and to extract the expected performance. As another example, in order to reflect the temperature arrival time and temperature change time according to the cargo weight and volume, the allowable temperature range can be reduced in response to the fact that the temperature increases slowly in the case of an increase in the cargo weight and volume. As another example, in order to consider the possibility of deterioration of the refrigeration quality depending on the operating time of the vehicle V, the allowable reference deviation can be reduced to strengthen the ratio of the constant temperature to the total operating time when the vehicle V is expected to operate for a long time. As another example, in order to take into account heat losses in the refrigerated cargo and thermal efficiency of the refrigeration unit 13, the allowable temperature range can be reduced when the weather outside is hot, so that offsets from the target temperature can be detected early.

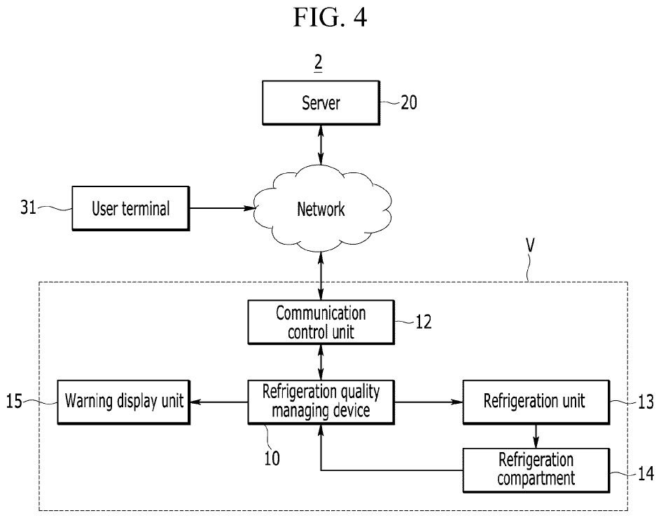

FIG. 4 is a diagram illustrating the refrigeration quality management system.

Referring now to FIG. 4, a refrigeration quality management system 2 can include a vehicle V including the refrigeration quality managing device 10 and a server 20, and unlike the refrigeration quality management system 1 previously described with reference to FIG. 1, a user (e.g., a driver of the refrigeration vehicle) can input the type of refrigerated cargo loaded into the refrigeration vehicle via a user terminal 31. In some examples, the user terminal 31 can include various types of computing devices, including smartphones, tablet computers, laptop computers, wearable devices, desktop computers, and the like. For example, a user can input whether the refrigerated cargo loaded into the refrigeration vehicle is of the type of ice cream, frozen fish, frozen processed food, and the like via an application running on the user terminal 31 in the user's possession, even when the user is not in the vehicle V.

In some examples, the user terminal 31 can receive input from a user, via a user interface, regarding the type of refrigerated cargo before operation of the refrigeration unit 13 begins. Subsequently, the user terminal 31 can transmit information regarding the type of refrigerated cargo input from the user to the server 20 via the communication interface 12. Upon receiving the information, the server 20 can provide the refrigeration quality reference data corresponding to the type of refrigerated cargo to the refrigeration quality managing device 10 via the communication interface 12.

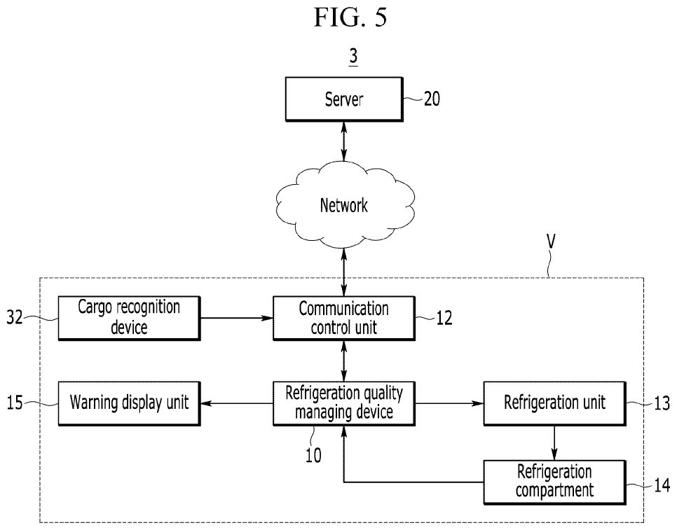

FIG. 5 is a diagram illustrating an example of a refrigeration quality management system.

Referring now to FIG. 5, a refrigeration quality management system 3 can include a vehicle V including the refrigeration quality managing device 10 and a server 20, and unlike the refrigeration quality management systems 1 and 2 previously described with reference to FIGS. 1 and 4, the type of refrigerated cargo loaded into the vehicle V can be recognized by using a cargo recognition device 32 mounted in the vehicle V. In some examples, the cargo recognition device 32 can include a radio frequency identification (RFID) device or a near field communication (NFC) device. For example, a user can input whether the refrigerated cargo loaded into the refrigeration vehicle corresponds to the type of ice cream, frozen fish, frozen processed food, or the like, by tagging or hovering the refrigerated cargo to the cargo recognition device 32 and then loading the refrigerated cargo into the refrigeration vehicle, rather than having to input the type of cargo loaded into the refrigeration vehicle directly through the vehicle infotainment system 30 or user terminal 31. Thereafter, the cargo recognition device 32 can transmit information regarding the recognized type of refrigerated cargo to the server 20 via the communication interface 12. Upon receiving the information, the server 20 can provide the refrigeration quality reference data corresponding to the type of refrigerated cargo to the refrigeration quality managing device 10 via the communication interface 12.

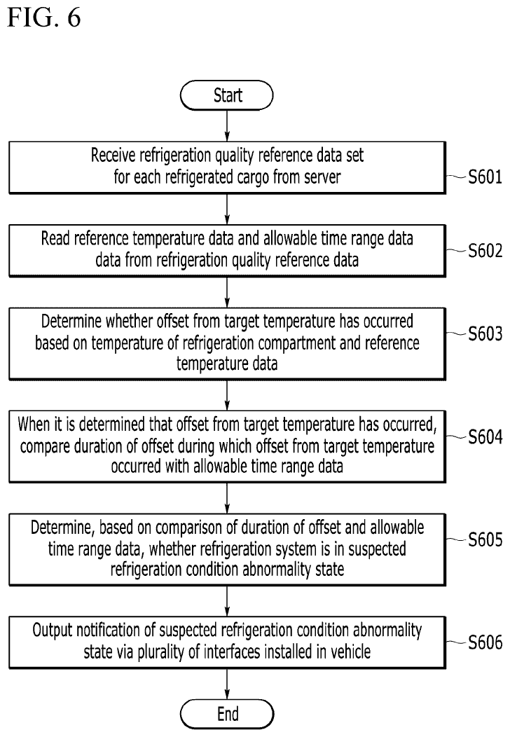

FIG. 6 is a diagram illustrating an example of a refrigeration quality managing method.

Referring to FIG. 6, a refrigeration quality managing method can include receiving refrigeration quality reference data set for each refrigerated cargo from a server (S601), reading reference temperature data and allowable time range data from the refrigeration quality reference data (S602), determining whether an offset from a target temperature has occurred based on a temperature of a refrigeration compartment and the reference temperature data (S603), when it is determined that the offset from the target temperature has occurred, comparing duration of the offset during which the offset from the target temperature occurred with the allowable time range data (S604), determining, based on the comparison of the duration of the offset and the allowable time range data, whether a refrigeration system is in a suspected refrigeration condition abnormality state (S605), and outputting a notification of the suspected refrigeration condition abnormality state via a plurality of interfaces installed in a vehicle (S606).

For further details of the above methods, reference can be made to the examples described herein, so that duplicative description is omitted herein.

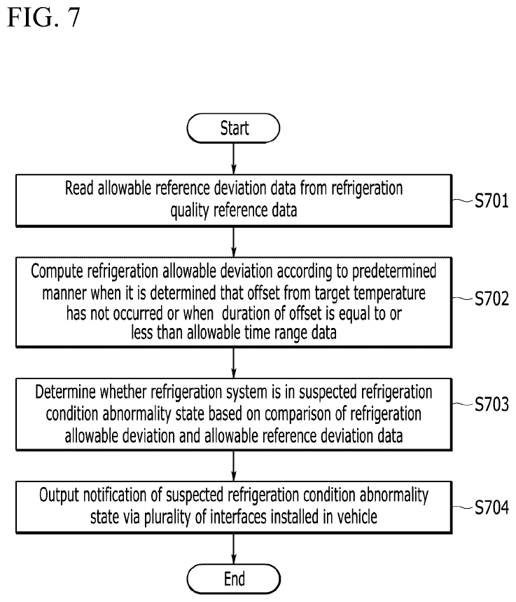

FIG. 7 is a diagram illustrating an example of a refrigeration quality managing method.

Referring to FIG. 7, the refrigeration quality managing method can include reading allowable reference deviation data from refrigeration quality reference data (S701), computing a refrigeration allowable deviation according to a predetermined manner when it is determined that the offset from the target temperature has not occurred or when the duration of the offset is less than or equal to the allowable time range data (S702), determining whether the refrigeration system is in the suspected refrigeration condition abnormality state based on the comparison of the refrigeration allowable deviation and the allowable reference deviation data (S703), and outputting a notification of the suspected refrigeration condition abnormality state via a plurality of interfaces installed in the vehicle (S704).

For further details of the above methods, reference can be made to the examples described herein, so that duplicative description is omitted herein.

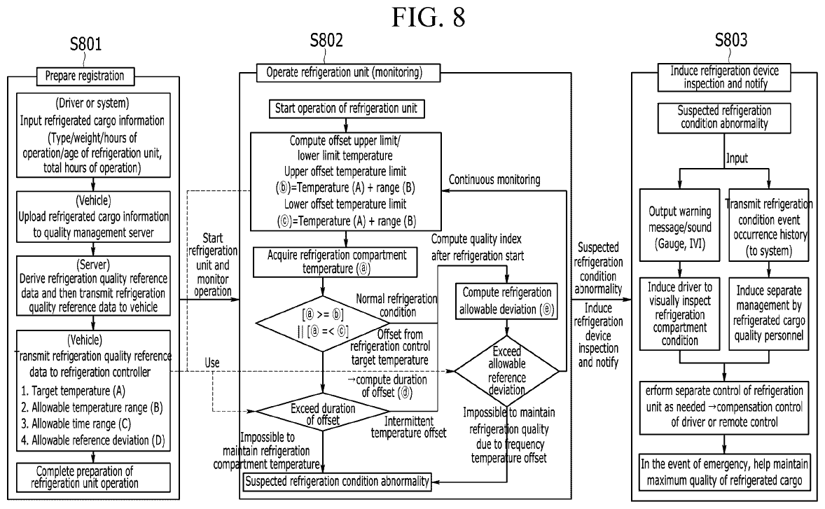

FIG. 8 is a diagram illustrating the refrigeration quality managing method.

Referring to FIG. 8, the refrigeration quality managing method can include a refrigeration preparation operation S801, a refrigeration unit operating operation S802 and a refrigeration device inspection induction and notification operation S803.

In the refrigeration preparation operation S801, to prepare refrigerated cargo transportation, a driver can input refrigerated cargo information by using a vehicle infotainment system installed inside the vehicle, a user terminal running a driver mobile application, an RFID/NFC-based cargo recognition device, or the like. The information input can include the type of refrigerated cargo, weight, hours of operation, age of the refrigeration unit, and total hours of operation of the refrigeration unit. The input refrigerated cargo information is uploaded to an external server (quality management server), and the server can derive its own refrigeration quality reference data and transmit the derived refrigeration quality reference data to the vehicle. In some examples, the refrigeration quality reference data transmitted to the refrigeration controller (i.e., the refrigeration quality managing device) can include a target temperature A, an allowable temperature range B, an allowable time range C, and an allowable reference deviation D. The vehicle receiving the refrigeration quality reference data can transmit the contents of the refrigeration quality reference data to the refrigeration controller, and the refrigeration controller can prepare a monitoring action based on the refrigeration quality reference data.

In the refrigeration unit operating operation S802, when the refrigeration unit starts operating, an upper offset temperature limit b and a lower offset temperature limit c can be computed by using the target temperature A and the allowable temperature range B. For example, the upper offset temperature limit b can be computed as the target temperature A+the allowable temperature range B, and the lower offset temperature limit c can be computed as the target temperature A−the allowable temperature range B. Then, the refrigeration compartment temperature a can be obtained, and it can be checked whether the refrigeration compartment temperature is greater than or equal to the upper offset temperature limit [(a)>=(b)] or whether the refrigeration compartment temperature is less than or equal to the lower offset temperature limit [(a)=<(c)]. When one of the two conditions is satisfied, it can be considered that the temperature of the refrigeration compartment deviates from the refrigeration control target temperature. When it is determined that the temperature of the refrigeration compartment deviates from the refrigeration control target temperature, duration of the offset d is computed, and when the duration of the offset d is greater than a specified allowable time range C, [(d)>(C)], the refrigeration condition is defined as a suspected refrigeration condition abnormality state. When it is not considered that the temperature of the refrigeration compartment deviates from the refrigeration control target temperature or the refrigeration condition is not defined as the suspected refrigeration condition abnormality state, the refrigeration condition can be determined to be valid and a refrigeration allowable deviation e can be computed. When the allowable reference deviation exceeds the refrigeration allowable deviation (refrigeration allowable deviation e >allowable reference deviation D), the refrigeration quality cannot be maintained due to frequent temperature offsets and can be defined as a suspected refrigeration condition abnormality state. When the refrigeration unit operation does not go to the suspected refrigeration condition abnormality state from the start to the termination of the operation, it can be determined that the refrigeration unit is normally operated.

The refrigeration allowable deviation e can be computed by dividing the total refrigeration unit operating time by the time the refrigeration compartment temperature is abnormal (the refrigeration unit operating time where (a)>=(b) or (a)=<(c)). For the normal refrigeration operation, the refrigeration allowable deviation e can be a numerical value close to 0%.

In refrigeration device inspection induction and notification operation S803, a warning message and sound can be output to the cluster, center fascia (or vehicle infotainment system) when the refrigeration condition is defined as the suspected refrigeration condition abnormality state. The warning message and sound output can notify the abnormality of the refrigeration condition and induce the driver to visually inspect the refrigeration compartment and take appropriate measures. At the same time, the refrigeration condition event occurrence (suspected refrigeration condition abnormality) history can be transmitted to the server, and the refrigerated cargo quality personnel can be guided to handle the event separately. It can be also possible to perform forced/compensated operation of the refrigeration unit via remote control. These measures ensure that the quality of refrigerated cargo is maintained as much as possible in the event of an emergency, compared to the existing case.

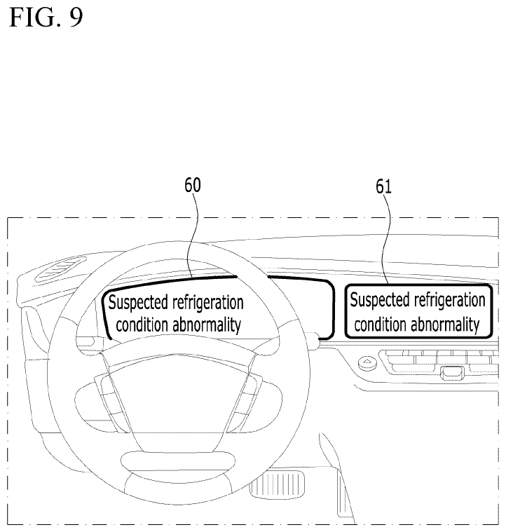

FIG. 9 is a diagram illustrating an example implementation of the refrigeration quality managing method and devices.

Referring to FIG. 9, in one implementation example, the notification of the suspected refrigeration condition abnormality state can be output through one or more interfaces installed within the vehicle V, such as the cluster 60 or the center fascia 61.

FIG. 10 is a diagram illustrating an example of a computing device.

Referring now to FIG. 10, the refrigeration quality managing method and devices can be implemented by using a computing device 50.

The computing device 50 can include at least one of a processor 510, a memory 530, a user interface input device 540, a user interface output device 550, and a storage device 560 communicating via a bus 520. The computing device 50 can also include a network interface 570 electrically connected to the network 40. The network interface 570 can transmit or receive a signal with another entity through the network 40.

The processor 510 can be implemented in various types, such as a micro controller unit (MCU), application processor (AP), a central processing unit (CPU), a graphic processing unit (GPU), a neutral processing unit (NPU), and a quantum processing unit (QPU), and can be a predetermined semiconductor device executing commands stored in the memory 530 or the storage device 560. The processor 510 can be configured to implement the function and the method described above with reference to FIGS. 1 to 9.

The memory 530 and the storage device 560 can include various forms of volatile or non-volatile storage media. For example, the memory can include a read only memory (ROM) 531 and a random access memory (RAM) 532. In the example, the memory 530 can be located inside or outside the processor 510, and the memory 530 can be connected with the processor 510.

In some examples, at least some configurations or functions of the refrigeration quality managing method and devices can be implemented as programs or software executed on the computing device 50, and the programs or software can be stored on a computer-readable medium. Specifically, a computer-readable medium can record a program for executing the operations included in an implementation of the refrigeration quality managing methods on a computer including the processor 510 executing a program or commands stored in the memory 530 or the storage device 560.

In some examples, at least some configurations or features of the refrigeration quality managing method and devices can be implemented using hardware or circuit of the computing device 50, or can be implemented as separate hardware or circuit that can be electrically connected to computing device 50.

In some cases, drivers operating refrigeration vehicles may periodically stop the vehicle to check the refrigeration quality of refrigerated cargo and open the refrigeration compartment to manually check the temperature, which delayed logistics time and caused driver fatigue, adversely affecting safe operation. In addition, the process of opening the refrigeration compartment increases a temperature, which reduces the refrigeration quality or increased the operation of the refrigeration unit, resulting in increased energy consumption. Furthermore, in providing logistics services, it may be difficult to quickly detect the deterioration of refrigeration quality, when quality abnormality occurs, which may lead to a loss of time and cost to respond to quality abnormality occurrence.

According to the present disclosure, it can be possible to manage refrigeration quality reference data, including data such as target temperature, allowable temperature range, allowable time range, and allowable reference deviation, for each refrigerated cargo, and quickly detecting the suspected refrigeration condition abnormality state by considering the refrigeration quality reference data and the refrigeration condition of the vehicle.

Although the above examples of the present disclosure have been described in detail, the scope of the present disclosure is not limited thereto, but also includes various modifications and improvements by one of ordinary skill in the art utilizing the basic concepts of the present disclosure as defined in the following claims.

What is claimed is:

1. A method for managing a refrigeration quality of a refrigerated cargo by detecting refrigeration condition abnormality of a refrigeration system of a vehicle, the method comprising:
receiving, from a server, refrigeration quality reference data for the refrigerated cargo;
obtaining (i) a reference temperature data comprising a target temperature of a refrigeration compartment of the vehicle and (ii) an allowable time range data comprising a preset allowable time range for detecting the refrigeration condition abnormality, the reference temperature data and the allowable time range data being set based on the refrigeration quality reference data;
determining whether an offset of a refrigeration compartment temperature of the vehicle from the target temperature has occurred;
based on determining that the offset from the target temperature has occurred, comparing the allowable time range data with a duration for which the offset has lasted; and
based on comparing the allowable time range data with the duration of the offset, determining whether the refrigeration system is in a suspected refrigeration condition abnormality state.

2. The method of claim 1, wherein the reference temperature data comprise a single value indicative of the target temperature, and
wherein the method further comprises obtaining, from the refrigeration quality reference data, allowable temperature range data comprising a preset allowable temperature range for detecting the refrigeration condition abnormality,
wherein determining whether the offset from the target temperature has occurred comprises:
determining an upper offset temperature limit and a lower offset temperature limit by using the single value and the allowable temperature range data;
determining that the offset from the target temperature has occurred based on the refrigeration compartment temperature (i) exceeding the upper offset temperature limit or (ii) being less than the lower offset temperature limit; and
determining that the offset from the target temperature has not occurred based on the refrigeration compartment temperature (i) being less than or equal to than the upper offset temperature limit and (ii) being greater than or equal to the lower offset temperature limit.

3. The method of claim 2, wherein the allowable temperature range data comprise first allowable temperature range data and second allowable temperature range data, and
wherein determining the upper offset temperature limit and the lower offset temperature limit comprises:
determining the upper offset temperature limit by adding the first allowable temperature range data to the single value; and
determining the lower offset temperature limit by subtracting the second allowable temperature range data from the single value.

4. The method of claim 1, wherein the reference temperature data comprise a target upper limit temperature and a target lower limit temperature that define a range of the target temperature, and
wherein determining whether the offset from the target temperature has occurred comprises:
determining that the offset from the target temperature has occurred based on the refrigeration compartment temperature (i) exceeding the target upper limit temperature or (ii) being lower than the target lower limit temperature; and
determining that the offset from the target temperature has not occurred based on the refrigeration compartment temperature (ii) being less than or equal to the target upper limit temperature and (ii) being greater than or equal to the target lower limit temperature.

5. The method of claim 1, wherein determining whether the refrigeration system is in the suspected refrigeration condition abnormality state comprises:
determining that the refrigeration system is in the suspected refrigeration condition abnormality state based on the duration of the offset exceeding the allowable time range data; and
determining that the refrigeration system is not in the suspected refrigeration condition abnormality state based on the duration of the offset being less than or equal to the allowable time range data.

6. The method of claim 2, further comprising:
obtaining, from the refrigeration quality reference data, allowable reference deviation data comprising a preset allowable reference deviation for detecting the refrigeration condition abnormality;
determining a refrigeration allowable deviation based on (i) determining that the offset from the target temperature has not occurred or (ii) the duration of the offset being less than or equal to the allowable time range data; and
based on comparing the refrigeration allowable deviation to the allowable reference deviation data, determining whether the refrigeration system is in the suspected refrigeration condition abnormality state.

7. The method of claim 6, wherein determining whether the refrigeration system is in the suspected refrigeration condition abnormality state comprises:
determining that the refrigeration system is in the suspected refrigeration condition abnormality state based on the refrigeration allowable deviation exceeding the allowable reference deviation data; and
determining that the refrigeration system is not in the suspected refrigeration condition abnormality state based on the refrigeration allowable deviation being less than or equal to the allowable reference deviation data.

8. The method of claim 6, wherein determining the refrigeration allowable deviation comprises:
determining the refrigeration allowable deviation by the duration of the offset divided by a total operating time of a refrigeration unit of the vehicle.

9. The method of claim 6, wherein the refrigeration quality reference data comprise (i) a plurality of types of the refrigerated cargo, (ii) the reference temperature data corresponding to each type of the refrigerated cargo, (iii) the allowable temperature range data corresponding to each type of the refrigerated cargo, (iv) the allowable time range data corresponding to each type of the refrigerated cargo, and (v) the allowable reference deviation data corresponding to each type of the refrigerated cargo.

10. The method of claim 1, further comprising:
outputting a notification regarding the suspected refrigeration condition abnormality state through one or more interfaces of the vehicle.

11. A method for managing a refrigeration quality of a refrigerated cargo by detecting refrigeration condition abnormality of a refrigeration system of a vehicle, the method comprising:
recognizing a type of the refrigerated cargo loaded into the vehicle by using a cargo recognition device disposed at the vehicle;
receiving, from a server, refrigeration quality reference data for the refrigerated cargo;
obtaining (i) a reference temperature data comprising a target temperature of a refrigeration compartment of the vehicle and (ii) an allowable time range data comprising a preset allowable time range for detecting the refrigeration condition abnormality, the reference temperature data and the allowable time range data being set based on the refrigeration quality reference data;
determining whether an offset of a refrigeration compartment temperature of the vehicle from the target temperature has occurred;
based on determining that the offset from the target temperature has occurred, comparing the allowable time range data with a duration for which the offset lasted; and
based on comparing the allowable time range data with the duration of the offset, determining whether the refrigeration system is in a suspected refrigeration condition abnormality state.

12. The method of claim 11, wherein the cargo recognition device comprises a radio frequency identification (RFID) device or a near field communication (NFC) device.

13. The method of claim 11, wherein the reference temperature data comprise a single value indicative of the target temperature, and
wherein the method further comprises obtaining, from the refrigeration quality reference data, allowable temperature range data comprising a preset allowable temperature range for detecting the refrigeration condition abnormality,
wherein determining whether the offset from the target temperature has occurred comprises:
determining an upper offset temperature limit and a lower offset temperature limit by using the single value and the allowable temperature range data;
determining that the offset from the target temperature has occurred based on the refrigeration compartment temperature (i) exceeding the upper offset temperature limit or being lower than the lower offset temperature limit; and
determining that the offset from the target temperature has not occurred based on the refrigeration compartment temperature (i) being less than or equal to the upper offset temperature limit and (ii) being greater than or equal to the lower offset temperature limit.

14. The method of claim 13, wherein the allowable temperature range data comprise first allowable temperature range data and second allowable temperature range data, and
wherein determining the upper offset temperature limit and the lower offset temperature limit comprises:
determining the upper offset temperature limit by adding the first allowable temperature range data to the single value; and
determining the lower offset temperature limit by subtracting the second allowable temperature range data from the single value.

15. The method of claim 11, wherein the reference temperature data comprise a target upper limit temperature and a target lower limit temperature that define a range of the target temperature, and
wherein determining whether the offset from the target temperature has occurred comprises:
determining that the offset from the target temperature has occurred based on the refrigeration compartment temperature (i) exceeding the target upper limit temperature or (ii) being lower than the target lower limit temperature; and
determining that the offset from the target temperature has not occurred based on the refrigeration compartment temperature (i) being less than or equal to the target upper limit temperature and (ii) being greater than or equal to the target lower limit temperature.

16. The method of claim 13, further comprising:
obtaining, from the refrigeration quality reference data, allowable reference deviation data comprising a preset allowable reference deviation for detecting the refrigeration condition abnormality;
determining a refrigeration allowable deviation based on (i) determining that the offset from the target temperature has not occurred or (ii) the duration of the offset being less than or equal to the allowable time range data; and
based on comparing the refrigeration allowable deviation with the allowable reference deviation data, determining whether the refrigeration system is in the suspected refrigeration condition abnormality state.

17. The method of claim 16, wherein the refrigeration quality reference data comprise (i) a plurality of types of the refrigerated cargo, (ii) the reference temperature data corresponding to each type of the refrigerated cargo, (iii) the allowable temperature range data corresponding to each type of the refrigerated cargo, (iv) the allowable time range data corresponding to each type of the refrigerated cargo, and (v) the allowable reference deviation data corresponding to each type of the refrigerated cargo.

18. The method of claim 11, further comprising:
outputting a notification regarding the suspected refrigeration condition abnormality state through one or more interfaces of the vehicle.

19. An apparatus configured to manage a refrigeration quality of a refrigerated cargo based on detecting refrigeration condition abnormality of a refrigeration system of a vehicle, the apparatus comprising one or more processes configured to execute a program code loaded in one or more memory devices,
wherein the one or more processes are configured to:
receive, from a server, refrigeration quality reference data of the refrigerated cargo,
obtain (i) a reference temperature data comprising a target temperature of a refrigeration compartment of the vehicle and (ii) an allowable time range data comprising a preset allowable time range for detecting the refrigeration condition abnormality, the reference temperature data and the allowable time range data being set based on the refrigeration quality reference data,
determine whether an offset of a refrigeration compartment temperature of the vehicle from the target temperature has occurred,
based on determining that the offset from the target temperature has occurred, compare the allowable time range data with a duration for which the offset has lasted, and
based on comparing the allowable time range data with the duration of the offset, determine whether the refrigeration system is in a suspected refrigeration condition abnormality state.

20. The apparatus of claim 19, wherein the reference temperature data comprise a single value indicative of the target temperature, and
wherein the one or more processes are further configured to:
obtain, from the refrigeration quality reference data, allowable temperature range data comprising a preset allowable temperature range for detecting the refrigeration condition abnormality;
determine an upper offset temperature limit and a lower offset temperature limit by using the single value and the allowable temperature range data;
determine that the offset from the target temperature has occurred based on the refrigeration compartment temperature (i) exceeding the upper offset temperature limit or (ii) being lower than the lower offset temperature limit; and
determine that the offset from the target temperature has not occurred based on the refrigeration compartment temperature (i) being less than or equal to the upper offset temperature limit and (ii) being greater than or equal to the lower offset temperature limit.

21. The apparatus of claim 20, wherein the allowable temperature range data comprise first allowable temperature range data and second allowable temperature range data, and
wherein the one or more processes are further configured to:
determine the upper offset temperature limit by adding the first allowable temperature range data to the single value; and
determine the lower offset temperature limit by subtracting the second allowable temperature range data from the single value.

22. The apparatus of claim 19, wherein the reference temperature data comprise a target upper limit temperature and a target lower limit temperature indicative of a range of the target temperature, and
wherein the one or more processes are further configured to:
determine that the offset from the target temperature has occurred based on the refrigeration compartment temperature (i) exceeding the target upper limit temperature or (ii) being lower than the target lower limit temperature; and
determine that the offset from the target temperature has not occurred based on the refrigeration compartment temperature (i) being less than or equal to the target upper limit temperature and (ii) being greater than or equal to the target lower limit temperature.

23. The apparatus of claim 19, wherein the one or more processes are further configured to:
determine that the refrigeration system is in the suspected refrigeration condition abnormality state based on the duration of the offset exceeding the allowable time range data; and
determine that the refrigeration system is not in the suspected refrigeration condition abnormality state based on the duration of the offset being less than or equal to the allowable time range data.

24. The apparatus of claim 19, wherein the one or more processes are further configured to:
obtain, from the refrigeration quality reference data, allowable reference deviation data comprising a preset allowable reference deviation for detecting the refrigeration condition abnormality;
determine a refrigeration allowable deviation based on (i) determining that the offset from the target temperature has not occurred or (ii) the duration of the offset being less than or equal to the allowable time range data; and
based on comparing the refrigeration allowable deviation with the allowable reference deviation data, determine whether the refrigeration system is in the suspected refrigeration condition abnormality state.

25. The apparatus of claim 24, wherein the one or more processes are further configured to:
determine that the refrigeration system is in the suspected refrigeration condition abnormality state based on the refrigeration allowable deviation exceeding the allowable reference deviation data; and
determine that the refrigeration system is not in the suspected refrigeration condition abnormality state based on the refrigeration allowable deviation being less than or equal to the allowable reference deviation data.
